(19) United States
(12) Patent Application Publication
(10) Pub. No.: US 2005/0276212 A1
(43) Pub. Date: Dec. 15, 2005

(54) Information record medium, and information record apparatus and method

(75) Inventors: Masahiro Kato, Saitama (JP); Eiji Muramatsu, Saitama (JP); Kunihiko Horikawa, Saitama (JP); Shoji Taniguchi, Saitama (JP); Kazuo Kuroda, Saitama (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 11/148,433

(22) Filed: Jun. 9, 2005

(30) Foreign Application Priority Data
Jun. 10, 2004 (JP) 2004-172545

(51) Int. Cl. G11B 7/24

(52) U.S. Cl. 369/275.1; 369/283; 369/272.1

(57) ABSTRACT

An information record medium is provided with: a first record layer (107) for recording first information, and one or more second record layers (207) disposed on said first record layer, each second layer being for recording second information, each layer of said second layers has a predetermined area (PCA1-1) where a power calibration is performed to detect an optimum recording power of recording laser beam transmitted through the first record layer and another layer of the second layers, said another layer positioned closer to said first record layer than said each layer, and in opposite areas (TA) of said another layer and said first record layer, said opposite areas being opposite to said predetermined area of said each layer of said second layers, a first absolute amount of at least one of width and depth of a groove is increased and thereby light transmittance in said opposite areas is approached to (i) light transmittance under an assumption that the first absolute amount is not increased and said another layer and said first record layer are in a recorded state, in comparison to (ii) light transmittance under an assumption that the first absolute amount is not increased and said another layer and said first record layer are in a non-recorded state.

### BACKGROUND OF THE INVENTION

1. Field of the Invention

The present invention relates to an information record medium such as a DVD and the like, and relates to an information record apparatus and method such as a DVD recorder and the like.

2. Description of the Related Art

As the information record medium such as a CD, a DVD and the like, there are developed a multiple layer type or dual layer type optical disc and so on, in which a plurality of record layers are formed on the same substrate. In the information record apparatus such as a CD recorder or the like for performing the recording relative to such a dual (or two) layer type optical disc, information is recorded onto a record layer (may be called “L0 layer” in this application) located at a topmost side as seen from a laser beam emission side, in a rewritable method or irreversible change record method (e.g. by heat), by focusing recording laser beam relative to the L0 layer, and information is recorded onto a record layer (may be called “L1 layer” in this application) located beyond the L0 layer as seen from the laser beam emission side, in a rewritable method or irreversible change record method (e.g. by heat), by focusing the laser beam relative to the L1 layer.

Furthermore, in the case that data information is recorded onto this kind of optical disc and the like, an optimum recording laser power (may be called “optimum recording power” in this application) is determined by an OPC (Optimum Power Control) process, depending on a type of the optical disc or a type of the information record reproduction apparatus, otherwise depending on the recording speed and so on. That is, a calibration is performed for the recording power. Thereby, it is possible to realize an appropriate recording operation corresponding to a dispersion of properties of an information record surface of the optical disc and the like. For example, once the optical disc is loaded and a writing command is inputted, data for a test writing is recorded into an OPC area with sequentially changing the optical intensity, so that a so-called “test writing process” is performed. Particularly, there is disclosed a technology in which the OPC area is disposed at each layer of two record layers, and the OPC process is performed respectively relative to these two layer.

Additionally, in the case of the dual layer type optical disc, in order to detect the optimum recording power relative to the L1 layer, the laser beam should appropriately respond to two kinds of record statuses of the L0 layer through which the laser beam transmits. That is why, usually, if the L0 layer are in a recorded status, light transmittance of the L0 layer directing to the L1 layer is decreased, and the optimum recording power value is increased. On the other hand, if the L0 layer is in a non-recorded status, the light transmittance of the L0 layer directing to the L1 layer is relatively high and the optimum recording power value is decreased.

Then, a technology is disclosed, for example by a patent document, Japanese Patent Application Laid-Open No. 2001-52337, in which the data information is recorded onto the L0 layer first of all, in order to perform the OPC process relative to the L1 layer, and then the OPC process is suitably performed relative to the L1 layer.

In the aforementioned OPC process relative to the L1 layer, however, there is a technical problem that a process is required for bringing the L0 layer, through which the laser beam transmits, into the recorded status, in order to detect the optimum recording power.

### SUMMARY OF THE INVENTION

The present invention has been accomplished in view of the above problem for example. It is therefore an object of the present invention to provide a multiple layer type information record medium capable of recording record information efficiently as well as performing a test writing efficiently, for example, relative to each of a plurality of record layers. It is further an object of the present invention to provide an information record apparatus and method capable of recording efficiently the record information onto such an information record medium.

The effect and advantages of the present invention will be apparent from the following embodiments.

(Embodiments of Information Record Medium)

The information record medium of the present invention is embodied in an information record medium provided with: a first record layer for recording first information which is at least a part of record information; and one or more second record layers disposed on said first record layer, each layer of said second layers being for recording second information which is at least another part of the record information; wherein said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers, in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (i) light transmittance under an assumption that the first absolute amount is not increased and said another layer of said second layers and said first record layer are in a recorded state, in comparison to (ii) light transmittance under an assumption that the first absolute amount is not increased and said another layer of said second layers and said first record layer are in a non-recorded state.

According to the embodiment of the information record medium of the present invention, for example, the first record layer and one or more second layers are formed on one surface of a disc-like substrate, in which the information record medium may be dual layer type or multiple layer type DVD or optical disc, and so on. The record information such as audio information, video information, otherwise content information and so on can be recorded onto the first layer. The record information such as audio information, video information, otherwise content information and so on can be recorded onto each layer of the second layers. Due to this structure, a recording or reproduction laser beam reaches the substrate, the first record layer, another layer of the second record layers, and each layer of the second record layers, in this order. More specifically, if each layer of the second record layers is “the second layer” as counted from an incident side of the recording laser beam, another layer of the second record layers does not exist. Furthermore, each layer of the second record layers is “the third layer”, there is only one layer as another layer of the second record layers. Still furthermore, each layer of the second record layers is “the fourth layer”, there are only two layers as another layer of the second record layer.

In each layer of the second record layers, there is disposed a predetermined area such as an OPC area or the like where a power calibration is performed in order to detect the optimum recording power of the recording laser beam.

Particularly in this embodiment, opposite areas which are opposite to the predetermined area are disposed in the first record layer and said another layer of the second record layers. The light transmittance of the first layer and said another layer of the second record layers can be decreased, by increasing the first absolute amount of at least one of width and depth of the groove in these opposite areas. Therefore, depending on the shape of groove, the light transmittance in these opposite areas, which are in the non-recorded status, of the first record layer and another layer of the second record layers can be approached to the light transmission in these opposite areas which are in the recorded status. In the case that the first absolute amount in these opposite areas are not increase, it is required for the information record apparatus as described below to perform a process of bringing these opposite areas of the first record layer and said another layer of the second record layers, through which the laser beam transmits, into the recorded status, in order to appropriately detect the optimum recording power in the predetermined area in said each layer of the second record layers.

On the contrary, according to this embodiment, for example, during the fabrication of the information record medium such as an optical disc or the like, the light transmittance of these opposite areas directing to the predetermined area of said each layer of the second record layers can be approached to the light transmittance under the assumption that the first absolute amount of these opposite areas is not increased and the first record layer and said another layer of the second record layers are in the recorded status, by increasing the first absolute amount in these opposite areas disposed in the first record layer and said another layer of the second record layers, in comparison to the light transmittance under the assumption that the first absolute amount in these opposite areas is not increased and the first record layer and said another layer of the second record layers are in the non-recorded status. Therefore, before the information record apparatus as described later performs the OPC process relative to each layer of the second record layers, the record operation for bringing the first record layer and said another layer of the second record layers into the recorded status can be omitted. Thus, it is possible to detect the optimum recording power relative to each layer of the second record layers, more quickly and more appropriately.

Incidentally, as described above, in order to form these opposite areas of the first record layer and said another layer of the second record layers, in such a manner that the light transmittance in these opposite areas is approached to the light transmittance under the assumption that the first absolute amount is not increased and the first record layer and said another layer of the second record layers are in the recorded status, in comparison to the light transmittance under the assumption that the first absolute amount is not increased and the first record layer and said another layer of the second record layer are in the non-recorded status, it is sufficient to obtain a desired light transmittance depending on individual cases, by increasing the first absolute amount experimentally, empirically, theoretically otherwise via simulations and so on.

In an aspect of the embodiment of the information record medium of the present invention, in said opposite areas, the first absolute amount is increased and thereby the light transmittance in said opposite areas equals to (i) light transmittance under an assumption that the first absolute amount is not increased and said another layer of said second layers and said first record layer are in the recorded state.

According to this aspect, it is possible to omit completely the recording operation for bring the light transmittance in these opposite areas equals to the light transmittance under the assumption that the first record layer and said another layer of the second record layer are in the recorded status. The expression “equals to” is implemented to include, in addition to “completely equals to”, “almost equals to” which can be handled as the same value for performing the power calibration.

In another aspect of the embodiment of the information record medium of the present invention, in said predetermined area, a second absolute amount of at least one of width and depth of a groove is increased or decreased and thereby light transmittance in said opposite areas is approached to (i) light transmittance under an assumption that the second absolute amount is not increased or decreased and said another layer of said second layers and said first record layer are in a recorded state, in comparison to (ii) light transmittance under an assumption that the second absolute amount is not increased or decreased and said another layer of said second layers and said first record layer are in a non-recorded state.

According to this aspect, the asymmetry value of each layer of the second record layers is decreased, by increasing or decreasing the second absolute amount of at least one of width and depth of the groove in the predetermined area of each layer of the second record layers. That is, it is possible to approximately form a status that the asymmetry value of each layer of the second record layers is decreased, similarly to the case that the laser beam directed to the predetermined area of said each layer of said second record layers transmits the first record layer and said another layer of the second record layers, which are in the recorded status.

Therefore, before the information record apparatus as described later performs the OPC process relative to said each layer of the second record layers, the recording operation for bringing the first record layer and said another layer of the second record layers into the recorded status can be omitted. Thus, it is possible to detect the optimum recording power value relative to each layer of the second record layers, more quickly and more appropriately.

In this aspect, in said predetermined area, the second absolute amount is increased or decreased and thereby the light transmittance in said opposite areas equals to (i) light transmittance under an assumption that the second absolute amount is not increased or decreased and said another layer of said second layers and said first record layer are in the recorded state.

In this arrangement, it is possible to omit completely the recording operation for bringing it equals to the light transmittance under the assumption that the first record layer and said another layer of the second record layer are in the recorded status.

In this aspect, said each layer of said second record layers further has a second coloring layer, wherein in said predetermined area, a thickness of said second coloring layer is increased or decreased and thereby the light transmittance in said opposite areas is approached to (i) light transmittance under an assumption that the thickness of said second coloring layer is not increased or decreased and said another layer of said second layers and said first record layer are in the recorded state, in comparison to (ii) light transmittance under an assumption that the thickness of said second coloring layer is not increased or decreased and said another layer of said second layers and said first record layer are in a non-recorded state.

In this arrangement, since the second coloring layer on the groove is formed thicker by increasing the second absolute amount of width of the groove of each layer of the second record layers, the asymmetry value of each layer of the second record layers typically tends to decrease. On the other hand, since the second coloring layer on the groove is formed thinner by increasing the second absolute amount of depth of the groove of each layer of the second record layers, the asymmetry value of each layer of the second record layer typically tends to increase.

Thus, it is possible to imaginarily generate a status that the asymmetry value of said each layer of the second record layers is decreased, by forming the second coloring layer thicker or thinner, similarly to the case that the laser beam directed to the predetermined area of each layer of the second record layers transmits the first record layer and said another layer of the second record layers, which are in the recorded status.

In another aspect of the embodiment of the information record medium of the present invention, said first record layer further has a first coloring layer, wherein in said opposite areas, a thickness of said first coloring layer is increased or decreased and thereby the light transmittance in said opposite areas is approached to (i) light transmittance under an assumption that the thickness of said first coloring layer is not increased or decreased and said another layer of said second layers and said first record layer are in the recorded state, in comparison to (ii) light transmittance under an assumption that the thickness of said first coloring layer is not increased or decreased and said another layer of said second layers and said first record layer are in a non-recorded state.

According to this aspect, since the first coloring layer of the groove is formed thicker by increasing the first absolute amount of width of the groove of the first record layer and said another layer of the second record layers, the light transmittance of the first record layer and said another layer of the second record layers typically tends to decrease. On the other hand, since the first coloring layer of the groove is formed thicker by increasing the first absolute amount of depth of the groove of the first record layer and said another layer of the second record layers, the light transmittance of the first record layer and said another layer of the second record layers typically tends to decrease.

Thus, the light transmittance of the first record layer and said another layer of the second record layer, which are in the non-recorded status, can be appropriately approached to the light transmittance of the first record layer and said another layer of the second record layers, which are in the recorded status.

In another aspect of the embodiment of the information record medium of the present invention, said predetermined area is a smaller area than each of said opposite areas.

According to this aspect, since the predetermined area where the OPC process is performed relative to each layer of the second record layers is smaller than said opposite areas, which is opposite to the predetermined area, in the first record layer and said another layer of the second record layer, it is possible to secure the margin, for example, taking account of irradiation of the laser beam or eccentric effect between layers of the dual layer type optical disc, and so on. Therefore, it is possible to detect the optimum recording power relative to each layer of the second record layers, more appropriately.

In another aspect of the embodiment of the information record medium of the present invention, at least one of said first record layer and said second record layers further has a management information record area for recording therein management information, wherein in said management information record area, there is recorded, as the management information, identification information indicating whether at least one of the first absolute amount and the second absolute amount is increased or decreased.

According to this aspect, for example, since the identification information such as a flag may be read by a seeking operation of the information record apparatus as described later, it is possible to realize the OPC process suitable to the information record medium, more quickly and more appropriately.

In another aspect of the embodiment of the information record medium of the present invention, said another layer of said second layers and said first record layer respectively has a first predetermined area where the power calibration is performed on said another layer of said second layers and said first record layer.

According to this aspect, in the predetermined area disposed at each layer of the second record layers, the power calibration is performed relative to each layer of the second record layers, via said opposite areas. On the other hand, in the first predetermined area disposed at the first record layer and said another layer of the second record layer, the power calibration is performed relative to the first record layer and said another layer of the second record layers.

More specifically, said opposite areas and the first predetermined area are formed in such a manner that they are displaces in a radial direction from each other so as not to be overlapped. Therefore, the laser beam for the test writing relative to the predetermined area transmits said opposite areas disposed at the first record layer and said another layer of the second record layers, and does not transmit the first predetermined area. Thereby, it is possible to avoid a case that the test writing in the predetermined area of each layer of the second record layers becomes incorrect, due to an effect of the status of the first predetermined area, i.e. depending on either of the recorded status or the non-recorded status with the test writing information.

If said opposite areas and the first predetermined area are not displaced and are overlapped, the optical property such as the light transmittance or the like changes in said opposite areas due to the effect of the first predetermined area. Thereby, the test writing performed relative to the predetermined area via these opposite areas becomes incorrect more or less.

In another aspect of the embodiment of the information record medium of the present invention, said each layer of said second record layers has a second predetermined area where the power calibration is performed on said each layer of said second record layers, in an area which is different from said predetermined area and not opposite to said opposite areas.

According to this aspect, each layer of the second record layers further has the second predetermined area for performing the power calibration with the aid of the recording laser beam transmitted through a certain part, which are in the non-recorded status, of the first record layer and said another layer of the second record layers. Therefore, it is possible to detect the optimum recording power corresponding to the recorded status of the first record layer and said another layer of the second record layers.

In another aspect of the embodiment of the information record medium of the present invention, at least one of said first record layer and said second record layer has a management area for recording therein the detected optimum record power value.

According to this aspect, the OPC process is performed on every recording operation of the information record apparatus as described later, or at the same time for the first record layer and each layer of the second record layers. Then, the optimum recording power value detected relative to each record layer of the first record layer and the second record layer by the OPC process is recorded into the management area. Then, it is possible to realize the recording operation more quickly and more appropriately, by reading the optimum recording power value recorded in the management area.

Incidentally, this optimum recording power value may be recorded into a memory device such as a memory within the information record apparatus as described later, for example, instead of recorded into the management area of the information record medium.

(Embodiment of Information Record Apparatus)

Now, an explanation will be made on the information record apparatus in the embodiment of the present invention.

The above object of the present invention is achieved by an information record apparatus for recording a record information into the information record medium comprising: (i) a first record layer for recording first information which is at least a part of the record information; and (ii) one or more second record layers disposed on said first record layer, each layer of said second layers being for recording second information which is at least another part of the record information; wherein (iii) said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers, (iv) in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (iv-1) light transmittance under an assumption that the first absolute amount is not increased and said another layer of said second layers and said first record layer are in a recorded state, in comparison to (iv-2) light transmittance under an assumption that the first absolute amount is not increased and said another layer of said second layers and said first record layer are in a non-recorded state, said apparatus comprising: a writing device for writing test writing information which is at least another part of the record information, into said first record layer, by irradiating said first record layer with the recording laser beam in such a manner that the recording laser beam is focused onto said first record layer, and for writing the test writing information into said each layer of said second record layers by irradiating said each layer of said second layers with the recording laser beam in such a manner that the recording laser beam is focused onto said each layer of said second record layers; and a test writing control device for controlling said writing device so as to (I) test-write the test writing information, via said opposite areas, for a power calibration of the recording laser beam in the predetermined area on said each layer of said second record layers, and (II) test-write the test writing information for the power calibration of the recording laser beam in first predetermined areas included respectively in areas differing from said opposite areas on said another layer of said second layers and said first record layer.

According to this aspect relating to the information record apparatus of the present invention, for example under control of the test writing control device including the CPU (Central Processing Unit) and the like, the OPC process relative to at least two record layers can be performed efficiently by the writing device including the optical pickup for example, with regard to the embodiment of the information record medium of the present invention described above.

That is, for example, it is possible to decrease the light transmittance in opposite areas directing to the predetermined area, by increasing the first absolute amount of at least one of width and depth of the groove in opposite areas disposed at the first record layer and said another layer of the second record layer, for example, during the fabrication of the information record medium such as the optical disc or the like. Therefore, depending on the shape of groove, the light transmittance in opposite areas, which are in the non-recorded status, of the first record layer and said another layer of the second record layers can be approached to the light transmittance in opposite areas which are in the recorded status. Therefore, under control of the test writing control device, before the writing device performs the OPC process relative to each layer of the second record layers, it is possible to omit, as appropriate, the recording operation for bringing the first record layer and said another layer of the second record layers into the recorded status. Therefore, according to the information record apparatus in this embodiment, it is possible to detect the optimum recording power value relative to each layer of the second record layers, more quickly and more appropriately.

Incidentally, the embodiment of the information record apparatus of the present invention can take various aspects, correspondingly to various aspects of the embodiment of the information record medium of the present invention as described above.

(Embodiment of Information Record Method)

Now, an explanation will be made on the information record method in an embodiment of the present invention.

The above object of the present invention is achieved by an information record method implemented with an information record apparatus provided with a writing device for test-writing test writing information, which is at least another part of the record information, in order to record a record information into a information record medium comprising: (i) a first record layer for recording first information which is at least a part of the record information; and (ii) one or more second record layers disposed on said first record layer, each layer of said second layers being for recording second information which is at least another part of the record information; wherein (iii) said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers, (iv) in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (iv-1) light transmittance under an assumption that the first absolute amount is not increased and said another layer of said second layers and said first record layer are in a recorded state, in comparison to (iv-2) light transmittance under an assumption that the first absolute amount is not increased and said another layer of said second layers and said first record layer are in a non-recorded state, said method comprising: a test writing control process for controlling said writing device so as to (I) test-write the test writing information, via said opposite areas, for a power calibration of the recording laser beam in the predetermined area on said each layer of said second record layers, and (II) test-write the test writing information for the power calibration of the recording laser beam in first predetermined areas included respectively in areas differing from said opposite areas on said another layer of said second layers and said first record layer.

According to the embodiment of the information record method of the present invention, similarly to the case of the embodiment of the information record apparatus of the present invention, under control of the test writing control process, before the OPC process is performed relative to each layer of the second record layers, it is possible to omit, as appropriate, the recording operation for bringing the first record layer and said another layer of the second record layers into the recorded status. Therefore, it is possible to detect the optimum recording power relative to each layer of the second record layers, more quickly and more appropriately.

Incidentally, the embodiment of the information record method of the present invention can also take various aspects, correspondingly to various aspects of the embodiment of the information record apparatus of the present invention.

The nature, utility, and further features of this invention will be more clearly apparent from the following detailed description with reference to preferred embodiments of the invention when read in conjunction with the accompanying drawings briefly described below.

As explained above, the embodiment of the information record medium of the present invention is provided with the first record layer and another layer of the second record layers, at which opposite areas are disposed for decreasing the light transmittance by increasing the first absolute amount of at least one of width and depth of the groove, and provided with said each layer of said second record layers, at which the predetermined area is disposed. Therefore, it is possible to detect the optimum recording power value relative to said each layer of said second record layers, more quickly and more appropriately. Furthermore, the embodiments of the information record apparatus and method of the present invention are provided with the writing device and the test writing control device and process. Therefore, it is possible to detect the optimum recording power value relative to said each layer of the second record layers, more quickly and more appropriately.

### BRIEF DESCRIPTION OF THE DRAWINGS

FIG. 1 are a substantial plan view showing a basic structure of an optical disc having a plurality of record areas in an embodiment of an information record medium of the present invention (FIG. 1A), and a schematic cross sectional view of the optical disc and a corresponding conceptual diagram showing a record area structure in the radial direction (FIG. 1B);

FIG. 2 is a partially enlargement view of a record surface of the optical disc in the first embodiment of the information record medium of the present invention.

FIG. 3 is a timing chart schematically showing an OPC process (in the case of 11 power steps) of detecting the optimum recording power relative to the optical disc in the first embodiment of the information record medium of the present invention.

FIG. 4 is a conceptual view schematically showing a reproduction RF signal in the OPC process (in the case of 11 power steps) of detecting the optimum recording power relative to the optical disc in the first embodiment of the information record medium of the present invention.

FIG. 5 is a graph plotting asymmetry values for each power step in the OPC process (in the case of 11 power steps) of detecting the optimum recording power relative to the optical disc in the first embodiment of the information record medium of the present invention.

FIG. 6 is a waveform chart showing a detail of one power step in the OPC process of detecting the optimum recording power relative to the optical disc in the first embodiment of the information record medium of the present invention.

FIG. 7 is a schematic sectional view enlarging a physical structure of an OPC area used for the OPC process of a dual layer type optical disc in the first embodiment of the information record medium of the present invention.

FIG. 8 is a graph showing a relationship between (i) the asymmetry value of L1 layer and (ii) a recording power (indicated as “write power” in the figure) relative to the L1 layer, in the case that no recording is done relative to L0 layer of the dual (or two) layer type optical disc in the first embodiment of the information record medium of the present invention, as well as in the case that an absolute amount of at least one of width and depth of the L0 layer groove is increased and a light transmittance of the non-recorded L0 layer is decreased to approach a light transmittance of the recorded L0 layer.

FIG. 9 are a graph showing an inter-relationship among width of the groove of the L0 layer of the dual layer type optical disc in the first embodiment of the information record medium of the present invention, the thickness of the coloring layer, and the light transmittance of the L0 layer under a condition that the recording power and the recording pulse are constant (FIG. 9(a)), and a graph showing an inter-relationship among depth of the groove of the L0 layer of the dual layer type optical disc in the first embodiment of the information record medium of the present invention, the thickness of the coloring layer, and the light transmittance of the L0 layer under a condition that the recording power and the recording pulse are constant (FIG. 9(b)).

FIG. 10 is a schematic sectional view showing a physical structure of the L0 layer (L1 layer) in the case that an absolute amount of a thickness of a coloring layer is changed, in addition to width or depth of the groove of the L0 layer (L1 layer) of the dual layer type optical disc in the first embodiment of the information record medium of the present invention.

FIG. 11 is a schematic sectional vies enlarging a physical structure in an OPC area used for an OPC process of a dual layer type optical disc in a comparative example.

FIG. 12 is a graph showing a relationship between the asymmetry value of L1 layer under a condition that the recording power and the recording pulse are constant and a recording power relative to the L1 layer, in the case that no recording is done relative to L0 layer of the dual layer type optical disc in the comparative example, as well as in the case that the L0 layer is recorded.

FIG. 13 is a schematic sectional vies enlarging a physical structure in an OPC area used for an OPC process of a dual layer type optical disc in a second embodiment of the information record medium of the present invention.

FIG. 14 is a graph showing a relationship between the asymmetry value of L1 layer and a recording power relative to the L1 layer, in the case that no recording is done relative to L0 layer of the dual layer type optical disc in the first embodiment of the information record medium of the present invention, as well as in the case that an absolute amount of at least one of width and depth of the L1 layer groove is increased.

FIG. 15 are a graph showing an inter-relationship among width of the groove of the L1 layer of the dual layer type optical disc in the second embodiment of the information record medium of the present invention, the thickness of the coloring layer, and the asymmetry value of the L1 layer under a condition that the recording power and the recording pulse are constant (FIG. 15 (a)), and a graph showing an inter-relationship among depth of the groove of the L1 layer of the dual layer type optical disc in the second embodiment of the information record medium of the present invention, the thickness of the coloring layer, and the asymmetry value of the L1 layer under a condition that the recording power and the recording pulse are constant (FIG. 15 (b)).

FIG. 16 is a block diagram conceptually showing a basic structure of the information record reproduction apparatus in an embodiment of the information record apparatus of the present invention.

FIG. 17 is a flow chart showing an OPC process and a recording operation relative to an optical disc by the information record reproduction apparatus in the embodiment of the information record apparatus of the present invention.

### DETAILED DESCRIPTION OF THE PREFERRED EMBODIMENTS

(Information Record Medium)

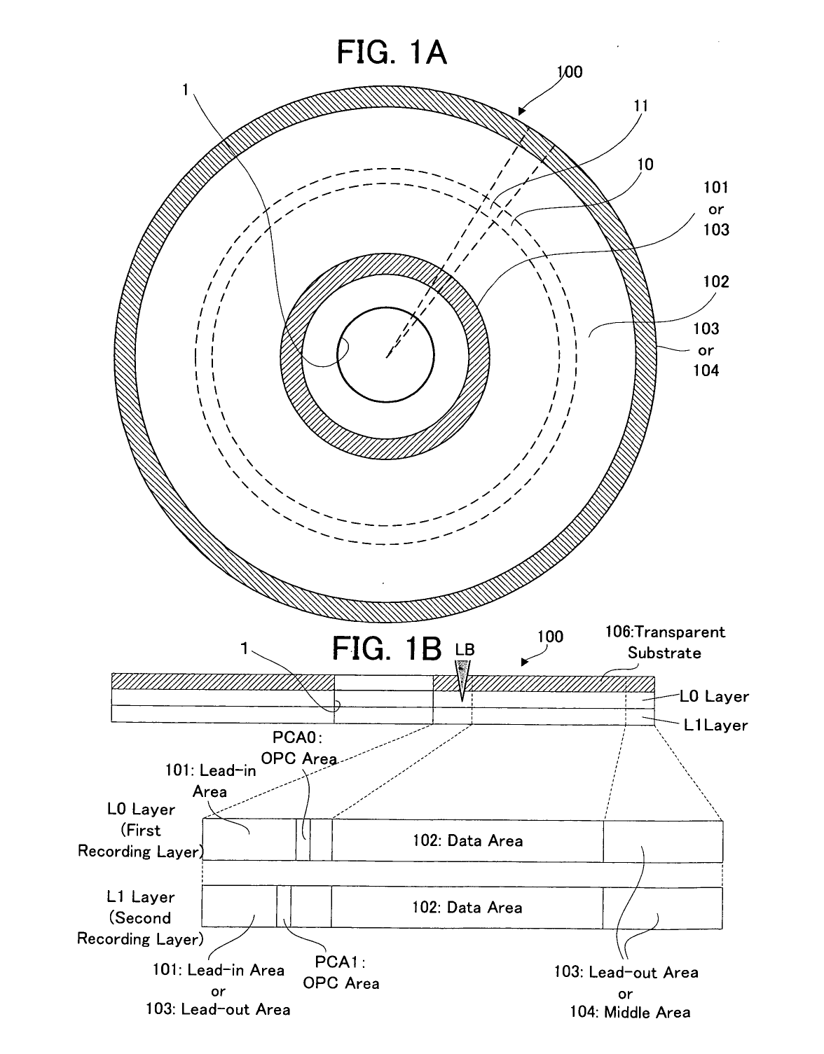

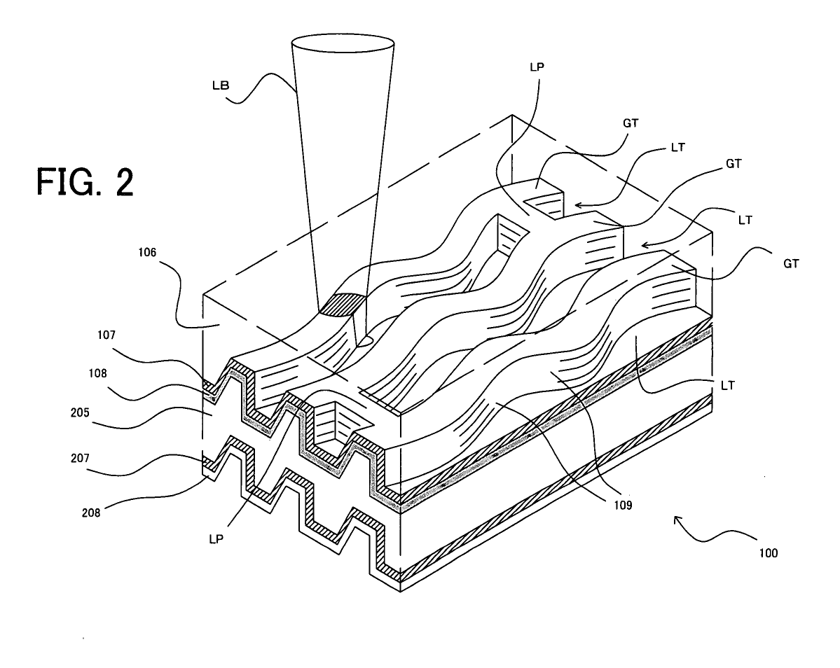

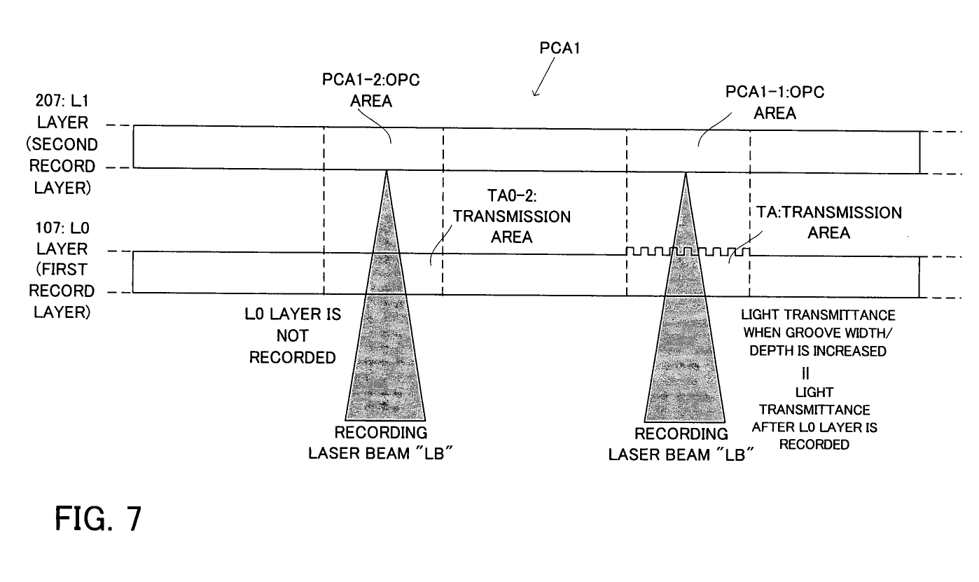

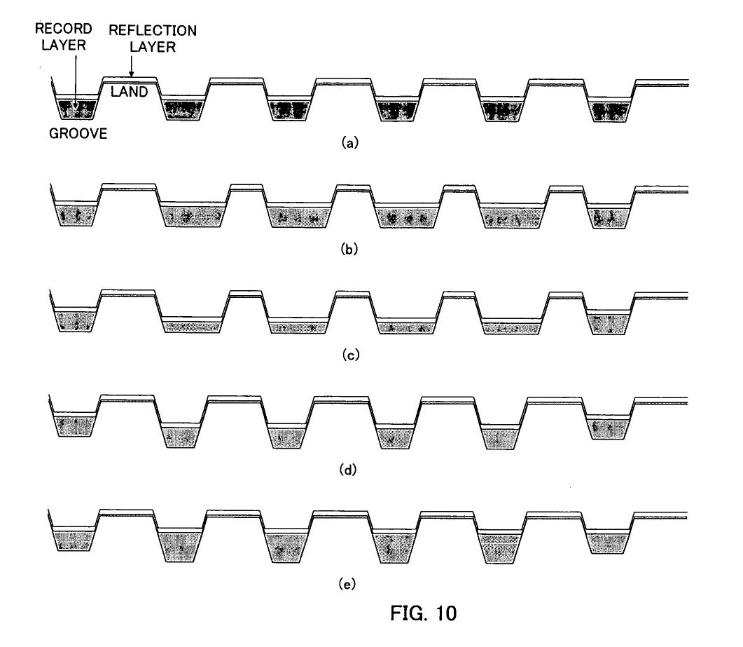

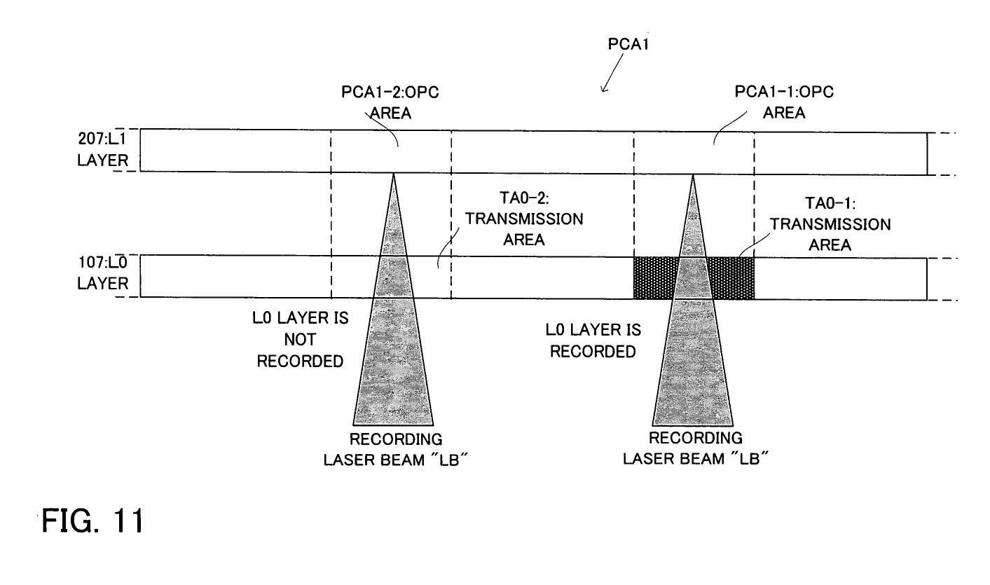

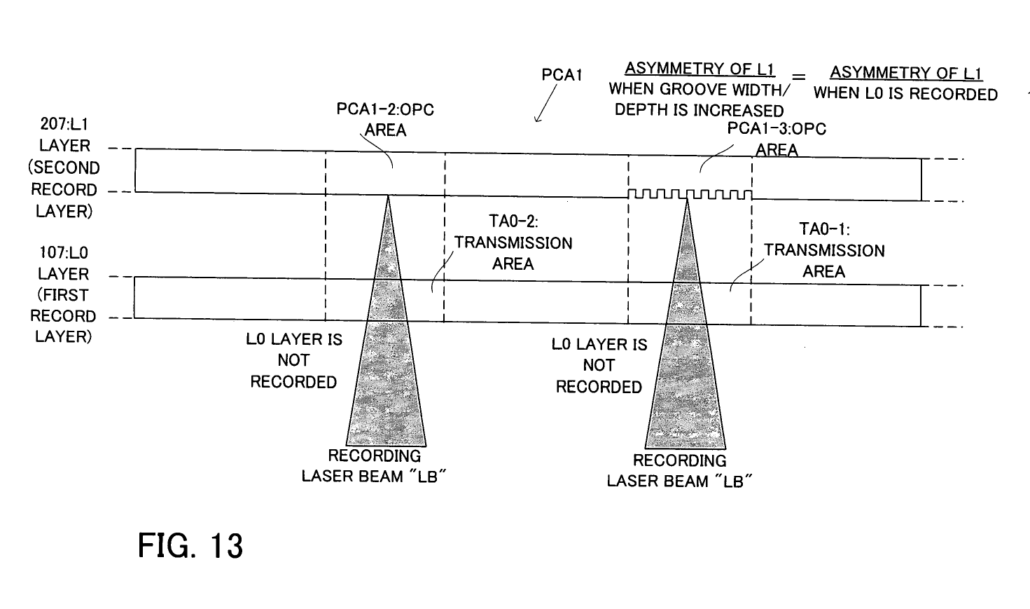

Next, with reference to FIG. 1 to FIG. 12, an optical disc in a first embodiment of the information record medium of the present invention will be explained in detail on the basis of the drawings. Incidentally, for convenience of explanation, in FIG. 1 and FIG. 2, laser light is emitted from the upper to the lower side. Therefore, an L0 layer (i.e. first record layer) is located at the upper side. On the other hand, in FIG. 7, FIG. 10, FIG. 11 and FIG. 13, the laser light is emitted from the lower to the upper side. Therefore, the L0 layer (i.e. first record layer) is located at the lower side.

Firstly, the basic structure of an optical disc in the embodiment of the information record medium of the present invention will be explained with reference to FIG. 1. FIG. 1 are a substantial plan view showing a basic structure of an optical disc having a plurality of record areas in a first embodiment of an information record medium of the present invention (FIG. 1A), and a schematic cross sectional view of the optical disc and a corresponding conceptual diagram showing a record area structure in the radial direction (FIG. 1B).

As shown in FIG. 1A and FIG. 1B, an optical disc 100 has a record surface (i.e. signal recording surface) on the disc main body with a diameter of about 12 cm, as is a DVD. On the record surface, the optical disc 100 is provided with: a lead-in area 101; a data area 102; and a lead-out area 103 or a middle area 104, which are associated with the embodiment, with a center hole 1 as the center. Particularly, for example, the lead-in area 101 is provided with, for example, an OPC area PCA0 or PCA1 for performing an OPC process. Then, a record layer or the like is formed on a transparent substrate 106 of the optical disc 100, for example. In each record area of the record layer, spirally or concentrically with the center hole 1 as the center, tracks 10, such as groove tracks and land tracks, are placed alternately. Moreover, on the track 10, data is divided by a unit of ECC block 11 and recorded. The ECC block 11 is a self-contained block of data and correction codes. On DVD media, this is a group of 16 DVD sectors.

Incidentally, the present invention is not particularly found or limited to the optical disc having three areas as described above. For example, even if the lead-in area 101, the lead-out area 103 or the middle area 104 does not exist, a data structure explained below can be constructed. Moreover, as described later, the lead-in area 101 and the lead-out area 103 or the middle area 104 may be further segmentized.

Particularly, the optical disc 100 in the embodiment, as shown in FIG. 1B, has such a structure that a L0 layer and a L1 layer, which constitute one example of the “first and second record layers” of the present invention as descried later, respectively, are formed on the transparent substrate 106. Upon the record and reproduction of such a dual layer type optical disc 100, the record reproduction in the L0 layer or the L1 layer is performed, depending on which record layer is provided with the focusing position of the laser light LB, emitted from the upper to the lower side. Moreover, the optical disc 100 in the embodiment is not found or limited to a dual layer single side, but may be a dual layer double side (or a double side). Furthermore, the optical disc 100 in the embodiment is not found or limited to the optical disc having the record layers of a dual layer type, as described above, but may be an optical disc of a multiple layer type which is three or more layers.

Incidentally, a record reproduction procedure in the dual layer type optical disc may be an opposite manner in which the directions of track passes are opposite between the two record layers for example, or may be a parallel manner in which the directions of track passes are equal between the two record layers for example.

Next, with reference to FIG. 2, an explanation will be made on a general physical structure of the optical disc in the first embodiment of the information record medium of the present invention. More specifically, the optical disc 100 in the first embodiment is constructed as a dual layer type optical disc in which a plurality of data area 102 etc. may be formed as a multi-layered structure. FIG. 2 is a partial enlargement of a record surface of the optical disc in the first embodiment of the information record medium of the present invention.

As shown in FIG. 2, in the first embodiment, the optical disc 100 is provided with a disc-like transparent substrate 106. On an under surface of the substrate, the first record layer (i.e. L0 layer) 107 is formed, which may be a phase change type or may be irreversible change type (e.g. by heat), for presenting an information record surface. On an under surface of the first record layer, a semi-transparent reflection layer 108 is formed. On the information record surface made of a surface of the first record layer 107, groove tracks GT and land tracks LT are formed alternately. Incidentally, during recording or reproduction on the optical disc 100, as shown in FIG. 2 for example, the groove tracks GT are irradiated with laser beam LB via the transparent substrate 106. For example, during the recording, they are irradiated with the laser beam LB of a recording laser power, so that a phase change recording or irreversible change recording (e.g. by heat) is performed relative to the first record layer 107, in response to the record information. On the other hand, during the reproduction, they are irradiated with the laser beam LB of a reproduction laser power which is lower than the recording laser power, so that a reading of the recorded data which is recorded into the first record layer 107 is performed.

In the first embodiment, groove tracks GT are oscillated with a constant amplitude and space frequency. That is, groove tracks. GT are wobbled, in which a cycle of wobbling 109 is set to a predetermined value. On land tracks LT, there are formed address pits, called land pre-pits LP, for indicating pre-format address information. These two addressing (i.e. wobbling 109 and land pre-pits LP) makes possible a disc rotation control or a recording clock generation during the recording, or obtain a necessary information for the data recording, such as a recording address. Incidentally, the pre-format address information may be pre-recorded by modifying wobbling 109 on groove tracks GT in a predetermined modulation method such as a frequency modulation method or a phase modulation method.

Particularly in the first embodiment, a second record layer (i.e. L1 layer) 207 is formed on the under surface of the semi-transparent reflection layer 108. Furthermore, a reflection layer 208 is formed on the under surface of the second record layer. Similarly to the first record layer 107, the second record layer 207 is irradiated with the laser beam LB via the transparent substrate 106, the first record layer 107 and the semi-transparent reflection layer 108, so that a phase change record/reproduction or irreversible change record/reproduction (e.g. by heat) is performed. These second record layer 207 and reflection layer 208 may be deposited or formed on the transparent substrate 106 on which the first record layer 107 and the semi-transparent reflection layer 108 are formed, or may be deposited or formed on another substrate and then laminated on the transparent substrate 106. Incidentally, depending on a fabrication method, a transparent intermediate layer 205, which may be made of transparent adhesive or the like, may be disposed between the semi-transparent reflection layer 208 and the second record layer 207.

On the recording/reproduction relative to such a dual layer type optical disc 100, the recording/reproduction is performed relative to the first or second record layer, in response to a focus position of the laser beam LB, i.e. depending on which record layer is focused.

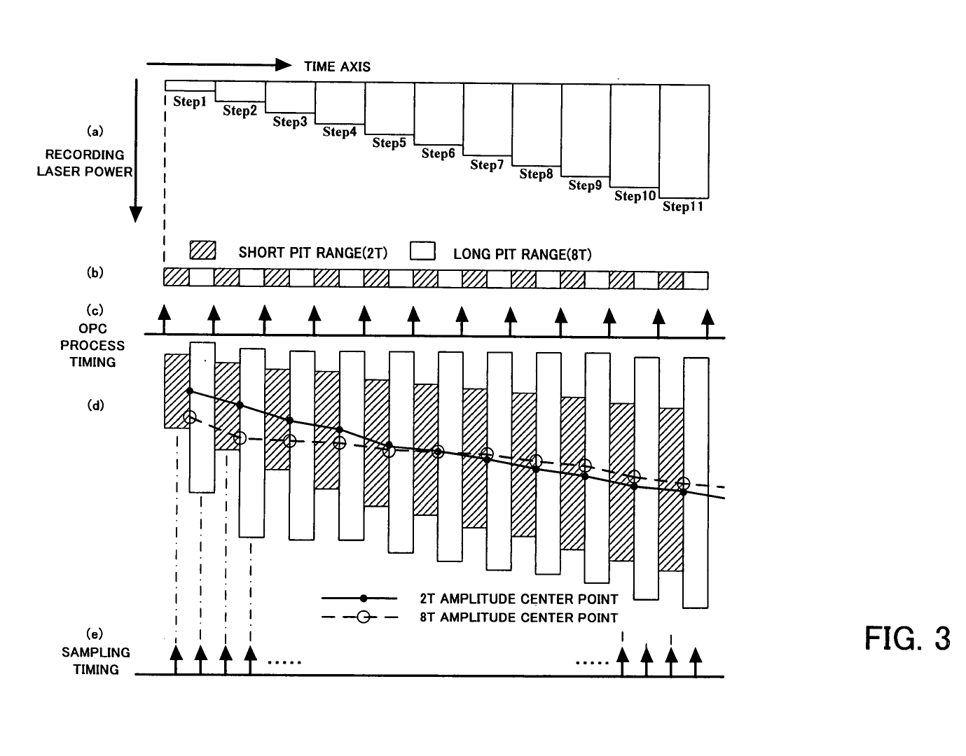

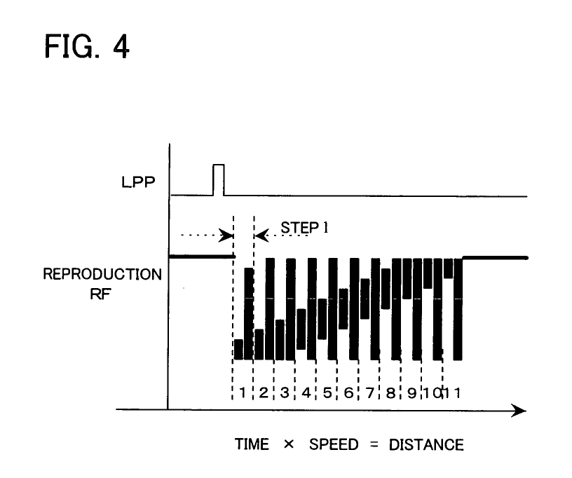

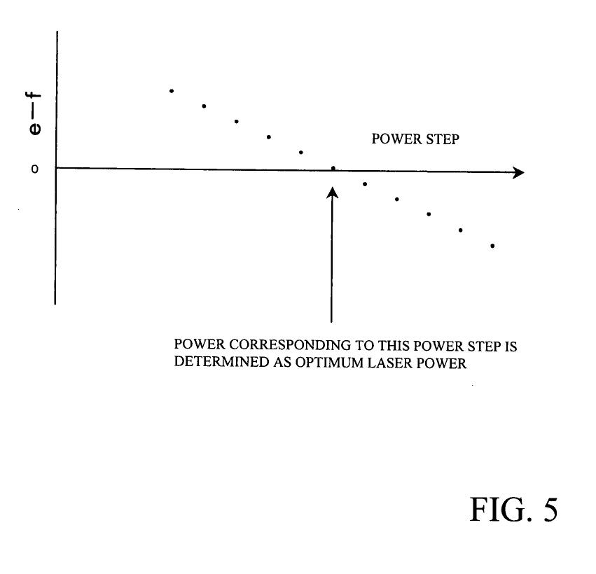

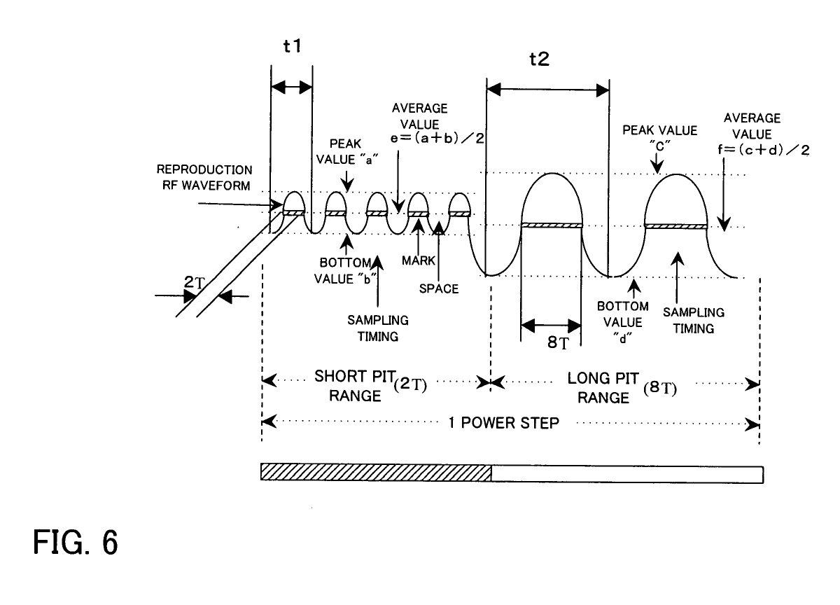

Next, with reference to FIG. 3 to FIG. 6, an explanation will be made on the OPC process (i.e. a calibration of the recording laser power) for detecting the optimum recording power relative to the optical disc, as a record object, in the first embodiment of the information record medium of the present invention. The expression “optimum recording power” herein is used in a broad sense to include a laser power sufficient to record the information more appropriately during the recording, in addition to a laser power literally optimum for the information recording. More specifically, it means a recording laser power for realizing a recording with the best reproduction quality having a minimum or almost minimum jitter value as an indicator of the recording quality, by minimizing an asymmetry effect. Furthermore, the “asymmetry” is a phenomenon in which a short pit or a long pit is slightly elongated or shortened by the same length at both side in a longitudinal direction, during the mass production of the optical disc. In this embodiment, the degree of the asymmetry effect is quantitatively indicated by the asymmetry value, which will be described later. FIG. 3 is a timing chart schematically showing the OPC process (in the case of 11 power steps) for detecting the optimum recording power relative to the optical disc, as an object, in the first embodiment of the information record medium of the present invention. The term “power step” herein means step for switching the recording laser intensity (power), for detecting the optimum recording power, in the OPC process. FIG. 4 is a conceptual diagram schematically showing a reproduction RF signal in the OPC process (in the case of 11 power steps) for detecting the optimum power relative to the optical disc, as an object, in the first embodiment of the information record medium of the present invention. FIG. 5 is a graph plotting asymmetry values for each power step in the OPC process (in the case of 11 power steps) for detecting the optimum power relative to the optical disc, as an object, in the first embodiment of the information record medium of the present invention. FIG. 6 is a waveform chart showing a detail of one power step in the OPC process (in the case of 11 power steps) for detecting the optimum power relative to the optical disc, as an object, in the first embodiment of the information record medium of the present invention.

In FIG. 3, a vertical axis of Graph (a) indicates the recording laser power value, and a horizontal axis is a time axis divided for each power step. Graph (b) indicates a time interval for emitting the generated laser beam which is switched alternately between a use for a short pit pulse (e.g. 2T pulse) and a use for a long pit pulse (e.g. 8T pulse). Graph (c) shows, by arrows, a timing for emitting the recording laser for calibrating 11 kinds of laser power different to each other. A vertical axis of Graph (d) indicates an amplitude voltage of the reproduction RF signal. Graph (e) shows, by arrows, a sampling timing for calculating the amplitude center voltage of the reproduction RF signal.

In this embodiment, the OPC area of the optical disc is irradiated with the recording laser for the calibration, as shown in the Graph (a) of FIG. 3, which may be divided for 11 power steps and emitted at 11 power levels different from each other, for example. In this case, at each power step, there is emitted the recording laser, which is a test signal made of the shortest pit and the longest pit of the 2-3 modulated signal, and which may be generated by switching alternately the short pit pulse (e.g. 2T pulse) and the long pit pulse (e.g. 8T pulse), in order to perform the recording. Herein, as shown in FIG. 3, a first half in one power step is assigned for a time to record the short pit pulse, which is defined as a “short pit range”. On the other hand, a last half in the same one step is assigned to time to record the long pit pulse, which is defined as a “long pit range”. Incidentally, as shown in FIG. 4, in one OPC process, as described above, the RF signal is reproduced relative to the time axis based on the land pre-pit(s).

As shown in FIG. 5, in this embodiment, a laser power corresponding to a power step in which the asymmetry value is zero is determined as the optimum recording power. Incidentally, a vertical axis of FIG. 5 indicates such an asymmetry value “e-f”, and the horizontal axis indicates the power step. An arrow indicates a power step in which “e=f” and thereby “asymmetry value=0”.

As explained above, detecting the optimum recording power in this embodiment (i.e. calibrating the recording laser power) is achieved by determining the optimum recording power corresponding to the power step in which “asymmetry value=0”. Particularly, it is possible to match timing between the OPC pattern recording and the OPC pattern reproduction, by a predetermined standard timing. Incidentally, the number of the power steps in one OPC process is not limited to 11, but may be the order of 10 to 20. Alternatively, it may be less or more. Furthermore, in this embodiment, the OPC pattern is made of 2T mark and 8T mark. Nevertheless, 3T mark, 7T mark and others may be used without limited to 2T mark and 8T mark.

Next, in this embodiment as shown in FIG. 6, at each power step, a plurality of 2T marks (5 marks in FIG. 6) are recorded by 2T pulse in one short pit range, and a plurality of 8T marks (2 marks in FIG. 6) are recorded by 8T pulse in one long pit range. Such a pair of short pit range and long pit range (i.e. a plurality of OPC pits having a predetermined pattern) is defined as an “OPC pattern”. One OPC process is completed by repeating such an OPC pattern as shown in FIG. 6 by the number of power steps (i.e. 11 times) with switching the laser power sequentially.

After such one OPC process completes repeating the OPC pattern recording, as shown in FIG. 6 for one power step, for all 11 power steps, then a process for reproducing these patterns is performed. Specifically, after the completion of recording the OPC patterns for all 11 power steps, the laser to be emitted to the OPC area is switched from the recording laser to the reproduction laser (e.g. the laser power is switched to the reproduction laser power remarkably weaker than the recording laser power). By emitting this reproduction laser, the reproduction process including an envelope detection and the like is performed as follows.

On the reproduction in the OPC process, a peak value and a bottom value of an envelope of a reproduction RF signal corresponding to the OPC pit (i.e. 2T mark) formed for example in the short pit range are sampled at the sampling timing indicated in the graph (e) of FIG. 3, and the amplitude center voltage is calculated. In the graph (e), this calculated amplitude center voltage is plotted as a black circle for each power step, and an interpolation of these values is shown as a black solid line. Similarly, a calculated amplitude center voltage of a reproduction RF signal corresponding to an OPC pit (i.e. 8T mark) formed for example in the long pit range is plotted as a white circle for each power step, and an interpolation of these values is shown as a broken line. An intersection between these two lines is indicated as a double circle, and a laser power of a power step corresponding to this double circle is determined as the optimum recording power.

More specifically, as shown in FIG. 6, a peak value of the envelope of the reproduction RF signal reproduced in the short pit range is defined as “a”, and a bottom value of the same is defined as “b”. Incidentally, “a” and “b” are sampled at the sample timing, as described above. The mean of these both values, which is the calculated amplitude center voltage, is defined as “e”. That is, “e=(a+b)/2”. Similarly, a peak value of the envelope of the reproduction RF signal reproduced in the long pit range is defined as “c”, and a bottom value of the same is defined as “d”. Then, the calculated amplitude center voltage is defined as “f=(c+d)/2”.

In this embodiment, the degree of the asymmetry effect is determined by comparing “e” with “f”. In FIG. 6, the amplitude center voltage “e” is different from and bigger than “f”. That is, the aforementioned “asymmetry value” is defined as “e-f”. Then, a laser power corresponding to a power step, at which “e=f” and “the asymmetry value=0”, is determined as the optimum recording power.

Next, with reference to FIG. 7 to FIG. 12, an explanation will be made on a principle of the OPC process for detecting the optimum recording power relative to L1 layer (i.e. the optimum recording power detected on L1 layer) of the dual layer type optical disc in the first embodiment of the information record medium of the present invention.

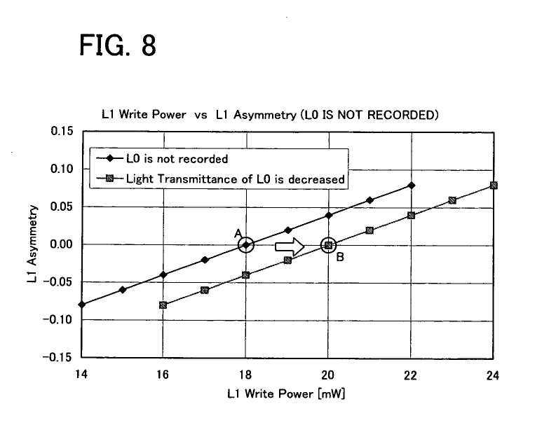

First of all, with reference to FIG. 7 and FIG. 8, an explanation will be made on a detail structure of the dual layer type optical disc in the first embodiment of the present invention, and a general principle of the OPC process for detecting the optimum recording power relative to the L1 layer. FIG. 7 is a schematic sectional view enlarging a physical structure of an OPC area used for the OPC process in the dual layer type optical disc in the first embodiment of the information record medium of the present invention. FIG. 8 is a graph showing a relationship between (i) the asymmetry value of L1 layer and (ii) a recording power (indicated as “write power” in the figure) relative to the L1 layer, in the case that no recording is done relative to L0 layer of the dual (or two) layer type optical disc in the first embodiment of the information record medium of the present invention, as well as in the case that an absolute amount of at least one of width and depth of the L0 layer groove is increased and a light transmittance of the non-recorded L0 layer is decreased to approach a light transmittance of the recorded L0 layer.

As shown in FIG. 7, the optical disc 100 has two record layers, i.e. L0 layer (i.e. a record layer corresponding to the first record layer 107 in FIG. 1 and FIG. 2) and L1 layer (i.e. a record layer corresponding to the second record layer 207 in FIG. 1 and FIG. 2). Incidentally, for convenience of explanation, the recording laser light LB is emitted from the lower to the upper side, on the contrary to FIG. 1 and FIG. 2.

The L0 layer is provided with a transmission area (or transparent area) TA in which an absolute amount of at least one of width and depth of a groove is increased presenting an example of the “opposite area” according to the present invention, and a non-recorded TA0-2, for example in the lead-in area.

On the other hand, the L1 layer is provided with an OPC area PCA1, for example in the lead-in area. Furthermore, the OPC area PCA1 is provided with an OPC area PCA1-1 and PCA1-2 presenting an example of the “predetermined area” according to the present invention.

Specifically, the OPC area PCA1 is an area used for a detection process of the optimum recording power (i.e. calibration of the recording laser power), so-called “OPC process”. Particularly, the OPC area PCA1 is used for detecting the optimum recording laser power relative to the L1 layer. More specifically, after a test writing of the OPC pattern is completed, the test-written OPC pattern is reproduced, and the reproduced OPC pattern is sampled sequentially, so that the optimum power is detected. Furthermore, if the optimum recording power value detected by the OPC process may be stored into a memory device (described later) such as a memory and the like, disposed at the information record apparatus side, or may be recorded into a management record area and the like, in the information record medium. Furthermore, the OPC process may be performed for every recording operation.

Then, the L0 layer and the L1 layer is irradiated with the laser beam LB for the OPC process, with the aid of the optical pickup of the information record reproduction apparatus (described later), from the substrate (not shown in the figure), i.e. from the lower to the upper side in FIG. 3. The focus distance of the laser beam LB and the like, are controlled, and a moving distance and direction of the laser beam LB in the radial direction on the optical disc 100 are controlled.

As shown in FIG. 8, particularly, in the dual layer type optical disc in the first embodiment of the information record medium of the present invention, for example during the fabrication, an absolute amount of at least one of width and depth of a groove in the transmission area TA of the L0 layer can be increased, and the light transmittance of the L0 layer can be decreased. Therefore, depending on the shape of groove, the light transmittance of the non-recorded L0 layer can be approached to the light transmission of the L0 layer. Therefore, as a result of the OPC process in the OPC area PCA1-1 of the L1 layer, it is possible to imaginally detect approximately 20 (mW) for the optimum recording power value in the case of the recorded L0 layer (i.e. the case that L0 layer is recorded).

Therefore, before the information record apparatus performs the OPC process relative to the L1 layer, the recording operation for bring the L0 layer into the recorded state can be omitted. Thus, it is possible to detect more quickly and more appropriately the optimum recording power value relative to the L1 layer.

On the other hand, it is possible to actually detect about 18 (mW) for the optimum recording power value relative to the L1 layer corresponding to the case of the non-recorded L0 layer (i.e. the case that L0 layer is not recorded), by emitting the recording laser beam LB through the transmission area TA0-2 in which the information is not recorded, to the OPC area PCA1-2 of the L1 layer.

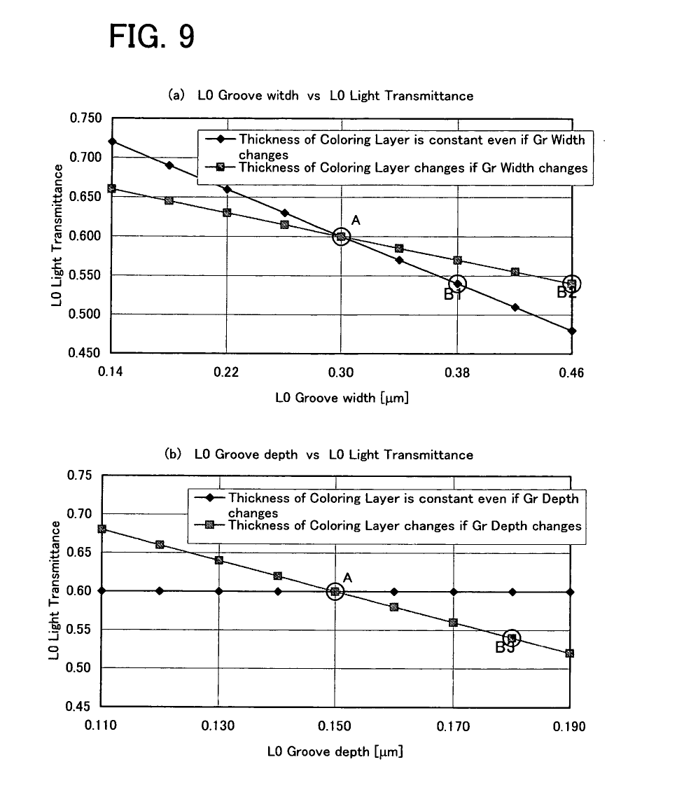

Next, with reference to FIG. 8 described above in addition to FIG. 9 and FIG. 10, a detail explanation will be made on a inter-relationship among the light transmittance of the L0 layer and an absolute amount of a thickness of a coloring layer in addition to the width and depth of the groove of the L0 layer of the dual layer type optical disc in the first embodiment of the information record medium of the present invention. FIG. 9 are a graph showing an inter-relationship among (i) width of the groove of the L0 layer of the dual layer type optical disc in the first embodiment of the information record medium of the present invention, (ii) the thickness of the coloring layer, and (iii) the light transmittance of the L0 layer under a condition that the recording power and the recording pulse are constant (FIG. 9(a)), and a graph showing an inter-relationship among (i) depth of the groove of the L0 layer of the dual layer type optical disc in the first embodiment of the information record medium of the present invention, (ii) the thickness of the coloring layer, and (iii) the light transmittance of the L0 layer under a condition that the recording power and the recording pulse are constant (FIG. 9(b)). Incidentally, a line interpolated among diamond shaped marks indicates the inter-relationship in the case that the thickness of the coloring layer is constant, even if an absolute amount of width or depth of a groove of the L0 layer is increased or decreased. Furthermore, a line interpolated among square shaped marks indicates the inter-relationship in the case that the thickness of the coloring layer changes, depending on that an absolute amount of width or depth of a groove of the L0 layer is increased or decreased. FIG. 10 is a schematic sectional view showing a physical structure of the L0 layer (L1 layer) in the case that an absolute amount of the coloring layer changes in addition to the change of the width or depth of the groove of the L0 layer (L1 layer) of the dual layer type optical disc in the first embodiment of the information record medium of the present invention.

As shown in the graph of FIG. 9 (a), and the sectional view of the physical structure of FIG. 10 (b), if the width of the groove of the L0 layer is increased, i.e. an absolute amount of the width is increased, a colorant accumulation increase in the groove, and thereby the light transmittance of the L0 layer generally tends to decrease. More specifically, as shown in FIG. 10 (c), the thickness of the coloring layer at a position where the width of the groove is more wide, may be thinner than the thickness of the coloring layer at a position of the usual width of the groove (see FIG. 10 (a)), because the colorant is coated by a spin coat process. In this case, the decrease ratio of the light transmittance is small.

More specifically, at a point “A” in FIG. 9 (a), the absolute amount of the width of the groove of the L0 layer is shown as 0.3 (μm), for example. At points “B1” and “B2”, there is shown that the light transmittance at the point “B1” or “B2” decreases by approximately 10% than the light transmittance at the point “A”, by increasing the width of the groove of the L0 layer by approximately 0.08 (μm) for the point “B1” or 0.16 (μm) for the point “B2” than the width of the groove at the point “A”.

On the other hand, as shown by a linear graph plotting square marks in FIG. 9 (b), or shown by the sectional view of the physical structure of FIG. 10 (e), if an absolute amount of the depth of the groove of the L0 layer is increased, a colorant accumulation increases in the groove, and thereby the light transmittance of the L0 layer generally tends to decrease. More specifically, as shown in FIG. 10 (e), the thickness of the coloring layer at a position where the depth of the groove is more deep, may be thicker than the thickness of the coloring layer at a position of the usual width of the groove (see FIG. 10 (a)), because the colorant is coated by a spin coat process. In the case of the same thickness of the coloring layer, as shown by a horizontal linear graph plotting diamond shaped marks in FIG. 9 (b) and shown by the sectional physical structure of FIG. 10 (d), however, the light transmittance of the L0 layer tends to less change, even if the absolute amount of the depth of the groove is increased.

More specifically, at the point “A” in FIG. 9 (b), there is shown that the absolute amount of the depth of the groove of the L0 layer is 0.15 (μm), for example. At a point “B3”, there is shown that the light transmittance is decreased by approximately 10% than the light transmittance at the point “A”, by increasing the depth of the groove of the L0 layer by approximately 0.03 (μm) than the depth at the point “A”. Therefore, it is possible to decrease the laser power, which actually reaches the L1 layer on the recording relative to the L1 layer, by approximately 10%.

Summarizing the aforementioned FIG. 9 (a) and FIG. 9 (b), the light transmittance of the L0 layer can be decreased from the point “A” to the point “B”, as shown in the aforementioned FIG. 8.

As described above, in the dual layer type optical disc in the first embodiment of the information record medium of the present invention, for example during the fabrication, it is possible to decrease the light transmittance of the L0 layer by increasing an absolute amount of at least one of width and depth of the groove in the transmission area TA of the L0 layer. Therefore, depending on the shape of groove, the light transmittance of the non-recorded L0 layer can be approached to the light transmittance of the recorded L0 layer. Therefore, as shown in the aforementioned FIG. 8, it is possible to imaginally detect about 20 (mW) for the optimum recording power in the case of the recorded L0 layer, as an OPC process in the OPC area PCA1-1 of the L1 layer.

Therefore, before the information record apparatus performs the OPC process relative to the L1 layer, the recording operation for bring the L0 layer into the recorded state can be omitted. Thus, it is possible to detect more quickly and more appropriately the optimum recording power value relative to the L1 layer.

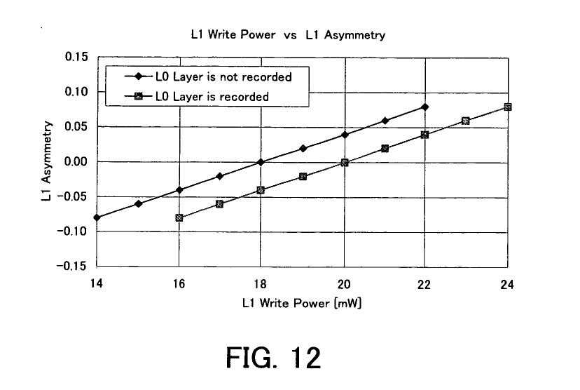

Next, with reference to FIG. 11 and FIG. 12 indicating an comparative example, a discussion will be made on an operation and effect of the dual layer type optical disc in the first embodiment of the information record medium of the present invention. FIG. 11 is a schematic sectional view enlarging a physical structure of an OPC area used for an OPC process in the dual layer type optical disc in the comparative example. FIG. 12 is a graph showing a relationship between (i) the asymmetry value of L1 layer under a condition that the recording power and the recording pulse are constant, and (ii) a recording power relative to the L1 layer, in the case that no recording is done relative to L0 layer of the dual layer type optical disc in the comparative example, as well as in the case that the L0 layer is recorded.

First of all, as shown in FIG. 11, in the comparative example, the L0 layer is provided with a recorded transmission area TA0-1 and a non-recorded transmission area TA0-2, for example in the lead-in area.

On the other hand, the L1 layer is provided with an OPC area PCA1, for example in the lead-in area, similarly to the aforementioned first embodiment.

Due to the structure as mentioned above, during the OPC process, as shown in FIG. 12, the light transmittance of the L0 layer tends to decrease in the case that the L0 layer is recorded. Thereby, it is understood that the optimum recording power of the L1 layer in the case that the L0 layer is recorded, is higher by approximately 2 (mW) than the optimum recording power of the L1 layer in the case that the L0 layer is not recorded.

As described above, since the optimum recording power differs between (i) the case that the transmission area TA0-1 of the L0 layer which is opposite to the OPC area PCA1-1 of the L1 layer, is recorded, and the case that the transmission area TA0-1 of the L0 layer is not recorded. Therefore there is required a process for bringing the transmission area TA0-1 of the L0 layer, through which the laser beam transmits, into a recorded state, by the information record apparatus as mentioned later, in order to appropriately detect the optimum recording power in the OPC area PCA1-1 of the L1 layer.

On the contrary, in the dual (or two) layer type optical disc in the first embodiment of the information record medium of the present invention, as described above, during the fabrication for example, the light transmittance of the L0 layer can be decreased by increasing an absolute amount of at least one of width and depth of the groove of the transmission area TA of the L0 layer. Therefore, depending on the shape of groove, the light transmittance of the non-recorded L0 layer can be approached to the light transmittance of the recorded L0 layer. Therefore, before the information record apparatus performs the OPC process relative to the L1 layer, the recording operation for bring the L0 layer into the recorded state can be omitted. Thus, it is possible to detect more quickly and more appropriately the optimum recording power value relative to the L1 layer.

(Second Embodiment of Information Record Medium)

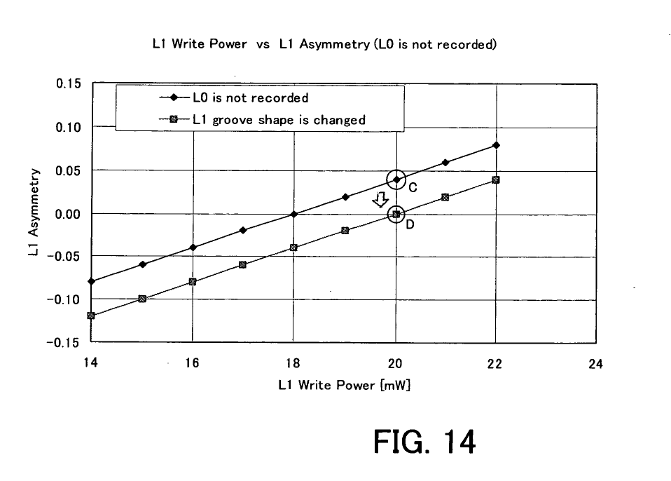

Next, with reference to FIG. 13 to FIG. 15 as well as the aforementioned FIG. 10 appropriately, an explanation will be made on a principle of the OPC process for detecting the optimum recording power relative to the L1 layer (i.e. the optimum recording power detected on L1 layer) of the dual layer type optical disc in a second embodiment of the information record medium of the present invention. FIG. 13 is a schematic sectional view enlarging a physical structure of an OPC area used for the OPC process in the dual layer type optical disc in the second embodiment of the information record medium of the present invention. FIG. 14 is a graph showing a relationship between (i) the asymmetry value of L1 layer and (ii) a recording power relative to the L1 layer, in the case that no recording is done relative to L0 layer of the dual layer type optical disc in the first embodiment of the information record medium of the present invention, as well as in the case that an absolute amount of at least one of width and depth of the L1 layer groove is increased.

The basic structure and the OPC process in the second embodiment of the information record medium of the present invention is almost the same as the first embodiment explained with reference to FIG. 1 to FIG. 12.

As shown in FIG. 13 and FIG. 14, particularly, in the dual layer type optical disc in the second embodiment of the information record medium of the present invention, during the fabrication for example, the asymmetry value of the L1 layer is decreased by increasing or decreasing an absolute amount of at least one of width and depth of the groove in the OPC area PCA1-3 of the L1 layer. That is, it is possible to imaginally generate a state at which the asymmetry value of the L1 layer is decreased, similarly to the case that the laser beam LB, which is directed (or emitted) to the OPC area PCA1-3 of the L1 layer, transmits through the recorded L0 layer. Incidentally, another example of the “predetermined area” according to the present invention is embodied by an OPC area PCA1-3. Thereby, as a result of the OPC process in the OPC area PCA1-3 of the L1 layer, it is possible to imaginally detect about 20 (mW) as the optimum recording power value in the case that the L0 layer is recorded.

Therefore, before the information record apparatus performs the OPC process relative to the L1 layer, the recording operation for bring the L0 layer into the recorded state can be omitted. Thus, it is possible to detect more quickly and more appropriately the optimum recording power value relative to the L1 layer.

On the other hand, similarly to the first embodiment, it is possible to actually detect about 18 (mW) as the optimum recording power value relative to the L1 layer corresponding to the case that the L0 layer is not recorded, by transmitting the recording laser beam LB through the transmission area TA0-2 of the non-recorded L0 layer and introducing or irradiating to the OPC area PCA1-2 of the L1 layer.

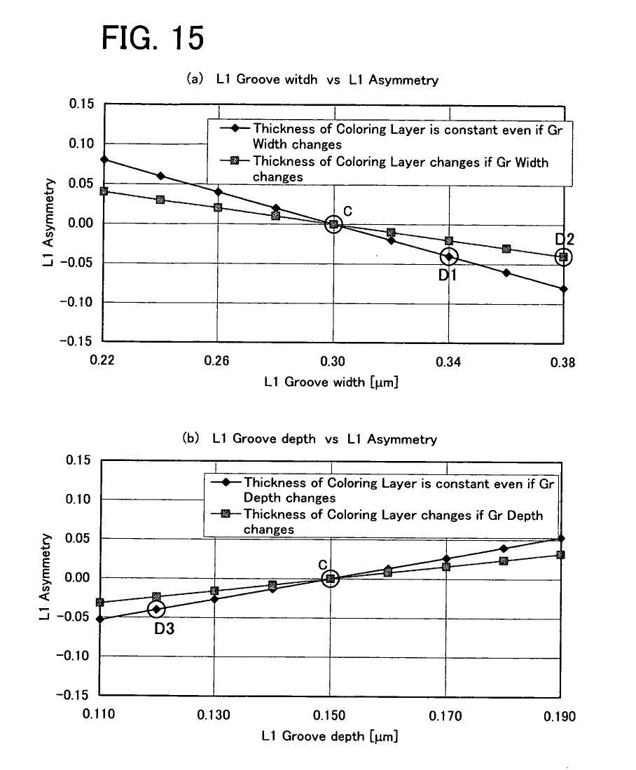

Next, with reference to FIG. 15 and the aforementioned FIG. 10 as well as the aforementioned FIG. 14 appropriately, an explanation will be made on a relationship among the asymmetry value of the L1 layer and an absolute amount of the thickness of the coloring layer, in addition to the width and depth of the groove of the L1 layer of the dual layer type optical disc in the second embodiment of the information record medium of the present invention. FIG. 15 are a graph showing an inter-relationship among (i) width of the groove of the L1 layer of the dual layer type optical disc in the second embodiment of the information record medium of the present invention, (ii) the thickness of the coloring layer, and (iii) the asymmetry value of the L1 layer under a condition that the recording power and the recording pulse are constant (FIG. 15 (a)), and a graph showing an inter-relationship among (i) depth of the groove of the L1 layer of the dual layer type optical disc in the second embodiment of the information record medium of the present invention, (ii) the thickness of the coloring layer, and (iii) the asymmetry value of the L1 layer under a condition that the recording power and the recording pulse are constant (FIG. 15 (b)). Incidentally, a line interpolated among diamond shaped marks indicates the inter-relationship in the case that the thickness of the coloring layer is constant, even if an absolute amount of width or depth of a groove of the L1 layer is increased or decreased. Furthermore, a line interpolated among square shaped marks indicates the inter-relationship in the case that the thickness of the coloring layer changes, depending on that an absolute amount of width or depth of a groove of the L1 layer is increased or decreased.

As shown in the graph of FIG. 15 (a), and the sectional view of the physical structure of FIG. 10 (b), if the width of the groove of the L1 layer is increased, i.e. an absolute amount of the width is increased, a colorant accumulation increase in the groove, and thereby the asymmetry value of the L1 layer generally tends to decrease. More specifically, as shown in FIG. 10 (c), the thickness of the coloring layer at a position where the width of the groove is more wide, may be thinner than the thickness of the coloring layer at a position of the usual width of the groove (see FIG. 10 (a)), because the colorant is coated by a spin coat process. In this case, the decrease ratio of the light transmittance is small.

More specifically, at a point “C” in FIG. 15 (a), the absolute amount of the width of the groove of the L1 layer is shown as 0.3 (μm), for example. At points “D1” and “D2”, there is shown that the asymmetry value decreases by approximately 0.04 than the asymmetry value at the point “C”, by increasing the width of the groove of the L1 layer by approximately 0.04 (μm) for the point “D1” or 0.08 (μm) for the point “D2” than the width at the point “C”.

On the other hand, as shown by a linear graph plotting square marks in FIG. 15 (b), or shown by the sectional view of the physical structure of FIG. 10 (e), if an absolute amount of the depth of the groove of the L1 layer is increased, a colorant accumulation increases in the groove, and thereby the asymmetry value of the L1 layer generally tends to increase. More specifically, as shown in FIG. 10 (e), the thickness of the coloring layer at a position where the depth of the groove is more deep, tends to be thicker than the thickness of the coloring layer at a position of the usual depth of the groove (see FIG. 10 (a)), because the colorant is coated by a spin coat process. In this case, the increase ratio of the asymmetry value of the L1 layer tends to be small. Furthermore, as shown by a horizontal linear graph plotting diamond shaped marks in FIG. 15 (b) and shown by the sectional physical structure of FIG. 10 (d), in the case of the same thickness of the coloring layer, the increase ratio in the asymmetry value of the L1 layer tends to be large, if the absolute amount of the depth of the groove is increased.

More specifically, at the point “C” in FIG. 15 (b), there is shown that the absolute amount of the depth of the groove of the L1 layer is 0.15 (μm), for example. At a point “D3”, there is shown that the asymmetry value is decreased by approximately 0.04 than the asymmetry value at the point “C”, by decreasing the depth of the groove of the L1 layer by approximately 0.03 (μm) than the depth at the point “C”.

Summarizing the aforementioned FIG. 15 (a) and FIG. 15 (b), the asymmetry value of the L1 layer can be decreased from the point “C” to the point “D”, as shown in the aforementioned FIG. 14.

As described above, in the dual layer type optical disc in the second embodiment of the information record medium of the present invention, for example during the fabrication, the asymmetry value of the L1 layer is decreased by increasing or decreasing an absolute amount of at least one of width and depth of the groove in the OPC area PCA1-3 of the L1 layer. That is, it is possible to imaginally generate a state at which the asymmetry value of the L1 layer is decreased, similarly to the case that the laser beam LB directed (or emitted) to the OPC area PCA1-3 of the L1 layer transmits through the recorded L0 layer. Thereby, as shown in the aforementioned FIG. 14, as a result of the OPC process in the OPC area PCA1-3 of the L1 layer, it is possible to imaginally detect about 20 (mW) as the optimum recording power value in the case that the L0 layer is recorded.

Therefore, before the information record apparatus performs the OPC process relative to the L1 layer, the recording operation for bring the L0 layer into the recorded state can be omitted. Thus, it is possible to detect more quickly and more appropriately the optimum recording power value relative to the L1 layer.

(Embodiment of Information Reproduction Apparatus)

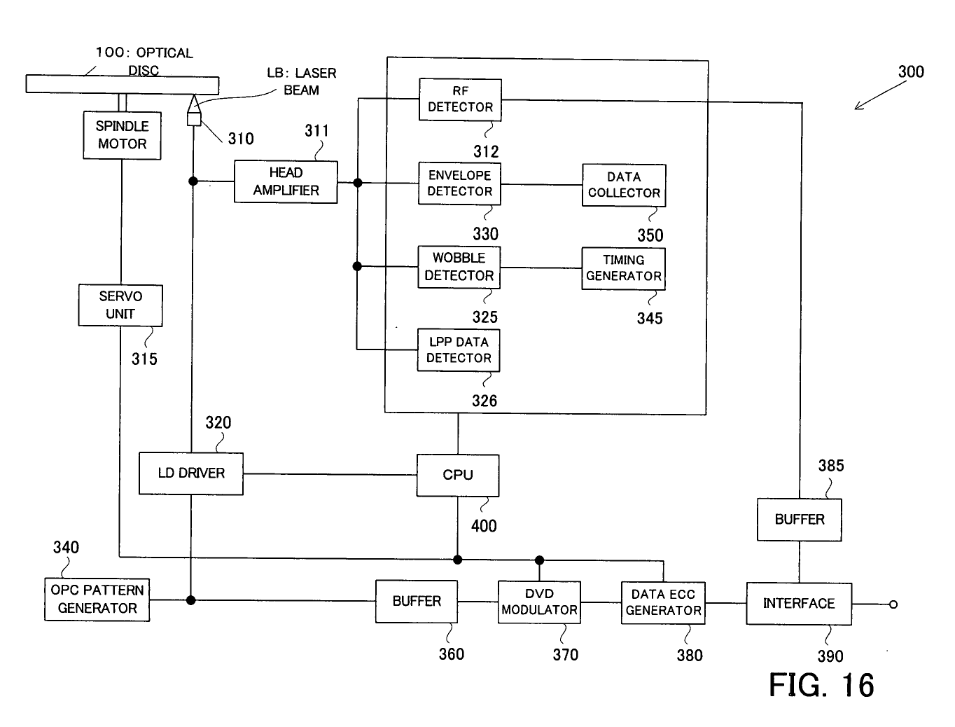

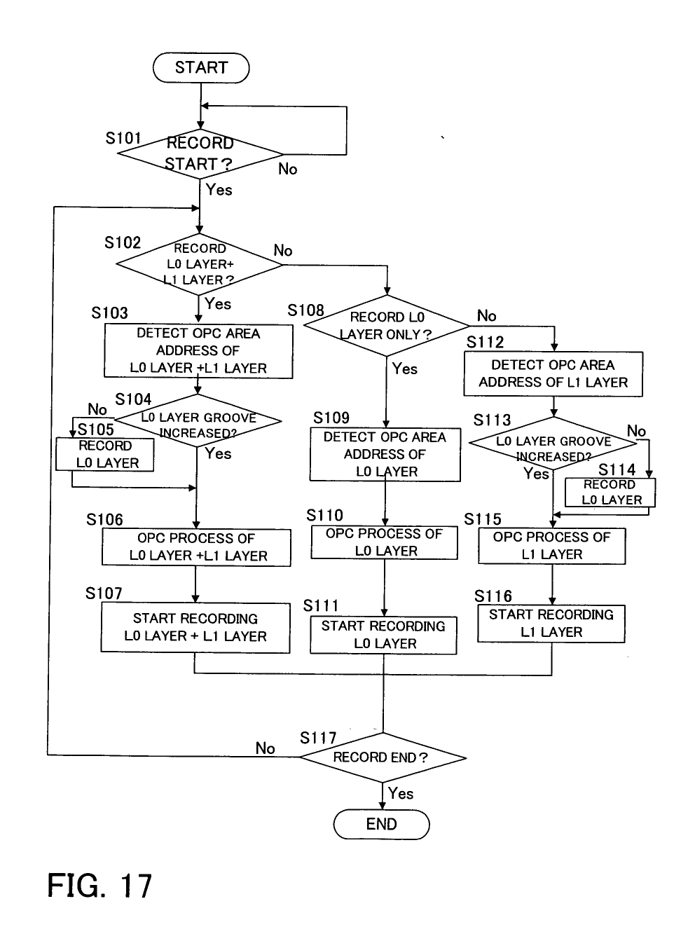

Next, with reference to FIG. 16 and FIG. 17, an explanation will be made on a structure and operation in an embodiment of the information record apparatus of the present invention. Particularly, in this embodiment, the information record apparatus of the present invention is applied to an information record reproduction apparatus for an optical disc.

(Information Record Reproduction Apparatus)

Next, with reference to FIG. 16, an explanation will be made on a basic structure of the information record reproduction apparatus in the embodiment of the information record apparatus of the present invention. FIG. 16 is a block diagram conceptually showing a basic structure of the information record reproduction apparatus in the embodiment of the information record apparatus of the present invention.

As shown in FIG. 16, the information record reproduction apparatus 300 in the embodiment is provided with: a spindle motor 301; an optical pickup 310; a head amplifier 311; an RF detector 312; a servo circuit 315; an LD driver 320; a wobble detector 325; an LPP data detector 326; an envelop detector 330; an OPC pattern generator 340; a timing generator 345; a data collector 350; a buffer 360; a DVD modulator 370; a data ECC generator 380; a buffer 385; an interface 390; and a CPU (Central Processing Unit) 400.

The spindle motor 301 is adapted to rotate an optical disc 100 at a predetermined speed under the spindle servo control of the servo circuit 315 and the like.

The optical pickup 310, which is composed of a semiconductor laser device, various lenses, an actuator and the like, is adapted to record or reproduce the optical disc 100. More specifically, the optical pickup 310 emits laser light to the optical disc 100 at a first power as a reading light for the reproduction, and emits the laser light with a second power as a writing light for the reading, with modulating the second power. The optical pickup 310 is adapted to move in a radial direction of the optical disc 100 with the aid of the actuator, a slider or the like (not shown) driven by the servo circuit 315.

The head amplifier 311 amplifies an output signal of the optical pickup 310 (i.e. a reflection light of the laser light LB) and outputs the amplified signal. Specifically, an RF signal as a reading signal is outputted to the RF detector 312 and the envelope detector 330, and a push-pull signal is outputted to the wobble detector 325 and the LPP data detector 326.

The RF detector 312 is adapted to detect the RF signal and demodulate the detected RF signal, and thereby output the reproduced data to an external device via the buffer 385 and the interface 390. Then, at the external device (an external output device) connected to the interface 390, a predetermined content is reproduced and outputted.

The servo circuit 315 moves an object lens of the optical pickup 310, in response to a tracking error signal, a focus error signal and the like which are obtained by processing the photoreceptive result at the optical pickup 310, and thereby performs various servo processings such as a tracking control, a focus control and the like. Furthermore, the servo circuit 315 is adapted to servo-control the spindle motor 301, on the basis of the wobble signal obtained by the wobble of the wobbled groove track of the optical disc 100.

During the OPC process, which will be described later, the LD driver 320 drives a semiconductor laser disposed in the optical pickup 310 so as to determine the optimum recording power on the basis of recording and reproducing the OPC pattern as described later. Then, the LD driver 320 drives the semiconductor laser of the optical pickup 310 at the optimum recording power determined in the OPC process, on the data recording. On this data recording, the optimum recording power is modulated depending on the recorded data.

Incidentally, the aforementioned spindle motor 301, optical pickup 310, servo circuit 315, LD driver 320 and the like present together a specific embodiment of the “writing device” according to the present invention.

The wobble detector 325 is adapted to detect the push-pull signal indicating the wobble signal and output it to the timing generator 345, on the basis of the output signal in response to photoreceptive amount from the head amplifier 311 as a detector for receiving a reflection light beam disposed in the optical pickup 310.

The LPP data detector 326 is adapted to detect the push-pull signal indicating the LPP signal, for example to detect the pre-format address information as described later, on the basis of the output signal in response to the photoreceptive amount from the head amplifier 311 as a detector for receiving the reflection light beam disposed in the optical pickup 310. Then, the LPP data detector 326 outputs the pre-format address information to the timing generator 345.

The envelope detector 330 is adapted to detect a peak value and a bottom value of the envelope detection wave of the RF signal as an output signal from the head amplifier 311, in order to determined the optimum recording power, under control of the CPU 400, on the reproduction of the OPC pattern in the OPC process. The envelope detector 330 may be adapted to include an A/D (Analog/Digital) converter and the like.

The OPC pattern generator 340 is adapted to output a signal indicating an OPC pattern to the LD driver 320, on the basis of the timing signal from the timing generator 345, on recording the OPC pattern in the OPC process before the recording operation.

The timing generator 345 detects absolute position information based on a management unit of pre-format address information (e.g. ADIP word), on the basis of the pre-format address information inputted from the LPP data detector 326, on recording the OPC pattern in the OPC process. Simultaneously, on the basis of a cycle of the push-pull signal indicating the wobble signal, the detector 345 detects relative position information based on a slot unit (e.g. a slot unit corresponding to a multiplied length by a natural number factor of one cycle of the wobble signal), which is a smaller unit than the management unit of the pre-format address information. Therefore, the timing generator 345 can specify the recording start position, regardless of that the recording start position in the OPC process starts from the management unit of the pre-format address information (i.e. starts from each boundary between ADIP words). After then, the timing generator 345 generates a timing signal for writing the OPC pattern and outputs the generated signal, on the basis of a cycle of the push-pull signal indicating the wobble signal outputted from the wobble detector 325. On the other hand, the timing generator 345 can specify the reproduction start position, similarly to recording, on reproducing the OPC pattern in the OPC process. After then, the timing generator 345 generates a timing signal for sampling the reproduced OPC pattern and outputs the generated signal, on the basis of a cycle of the push-pull signal indicating the wobble signal outputted from the wobble detector 325.

The data collector 350 is typically memory in general. For example, it may be made of an external RAM or the like. An envelope detected at the envelope detector 330 is stored into the data collector 350. On the basis of the stored envelope, detecting the optimum recording power in the CPU 400, i.e. the OPC process is performed.

The buffer 360 is adapted to store the recorded data modulated by the DVD modulator 370, and output it to the LD driver 320.

The DVD modulator 370 is adapted to perform a DVD modulation relative to the recorded data, and output it to the buffer 360. The DVD modulation may be a 8-16 modulation.

The data ECC generator 380 adds a code for error correction relative to the recorded data inputted from the interface 390. More specifically, an ECC code is added to the recorded data for each predetermined block unit (e.g. ECC cluster unit), and is outputted with the code to the DVD modulator 370.

The buffer 385 stores the reproduction data outputted from the RF detector 312, and outputs it to the external output device via the interface 390.

The interface 390 receives an input such as the recorded data or the like form the external input device, and outputs it to the ECC data generator 380. Furthermore, it may be adapted to output the reproduction data outputted from the RF detector 312 to the external output device such as a speaker, a display or the like.

The CPU 400 controls the entire information record reproduction apparatus 300, in order to detect the optimum recording power, for example by outputting an instruction i.e. a system command to each devices including the LD driver 320, the servo circuit 315 and the like. Usually, software for operating the CPU 400 is stored in an internal or external memory.

Incidentally, the aforementioned CPU 400, envelope detector 330, OPC pattern generator 340, timing generator 345, LD driver 320 and the like present together a specific embodiment of the “test writing control device” according to the present invention.

Furthermore, it should be appreciated that the information record reproduction apparatus 300 shown in FIG. 16 acts as an information record apparatus capable of recoding data, mainly with the aid of the optical pickup 310, the LD driver 320, the buffer 360, the DVD modulator 370, the data ECC generator 380 and other constitutional elements, and acts as an information reproduction apparatus capable of reproducing data, mainly with the aid of the optical pickup 310, the head amplifier 311, the RF detector 312 and other constitutional elements.

(Flow of Recording Operation by Information Record Reproduction Apparatus)

Next, with reference to FIG. 17, a detail explanation will be made on a recording operation and an OPC process flow of the optical disc in an embodiment of the information record reproduction apparatus of the present invention. FIG. 17 is a flow chart showing the recording operation and the OPC process flow of the optical disc of the information record reproduction apparatus in the embodiment of the information record apparatus of the present invention.

In FIG. 17, once the optical disc 100 is loaded first of all, the optical pickup 352 performs seek operation, under control of the CPU 354, in order to obtain various kinds of management information necessary for the recording process of the optical disc 100. On the basis of this management information, under control of the CPU 354, for example in response to an instruction from an external input device or the like, it is judged whether or not to start the data recording operation of the optical disc 100 via a data I/O (input/output) control device 306 (step S101). In the case of starting the data recording operation of the optical disc 100 (step S101: Yes), it is further judged whether or not the record layer to be a record object is the L0 layer and the L1 layer (step S102). If the record layer to be the record object is the L0 layer and the L1 layer (step S102: Yes), the address information is determined in an OPC area where the L0 layer and the L1 layer are subjected to the OPC process (step S103).

Then, in the transmission area TA or TA0-2 of the L0 layer opposite to the OPC area PCA1 of the L1 layer, it is judged whether or not an absolute amount of at least one of width and depth of the groove is increased (step S104). If an absolute amount of at least one of width and depth of the groove is increased in the transmission area TA or TA0-2 of the L0 layer (step S104: Yes), the OPC process is performed relative to the OPC area PCA0 of the L0 layer, and the OPC process is performed relative to the OPC area PCA1-1 of the L1 layer with the aid of the laser beam LB transmitted through the transmission area TA (step S106). Particularly, in this embodiment, as described above, therefore, since it is possible to omit the pre-recording operation relative to the transmission area TA of the L0 layer when the information record apparatus performs the OPC process relative to the OPC area PCA1-1 of the L1 layer, it is possible to detect the optimum recording power relative to the L1 layer, more quickly and more appropriately.

On the other hand, if an absolute amount of at least one of width and depth of the groove, in the transmission area TA or TA0-2 of the L0 layer (step S104: No), the recording operation is performed relative to the transmission area TA0-2 of the L0 layer (step S105), and thereby the recorded state is generated, and the process goes to the aforementioned step S106.

Then, at the optimum recording power detected in the OPC process at step S106, the data recording is performed relative to the L0 layer and the L1 layer (step S107).

On the other hand, as a result of the judgement at step S102, if the record layer to be a record object is not the L0 layer and the L1 layer (step S102: No), it is further judged whether or not the record layer to be a record object is the L0 layer only (step S108). If the record layer to be a record object is the L0 layer only (step S108: Yes), address information is determined in the OPC area PCA0 where the OPC process is performed relative to the L0 layer (step S109).

Then, the OPC process is performed relative to the OPC area PCA0 of the L0 layer (step S110).

Then, at the optimum recording power calculated at step S110, the data recording is performed relative to the L0 layer (step S111).

On the other hand, as a result of the judgement at step S108, if the record layer to be a record object is not the L0 layer only (step S108: No), address information is determined in the OPC area where the OPC process is performed relative to the L1 layer (step S112).

Then, it is judged whether or not an absolute amount of at least one of width and depth of the groove is increased, in the transmission area of the L0 layer opposite to the OPC area of the L1 layer (step S113). If an absolute amount of at least one of width and depth of the groove is increased, in the transmission area of the L0 layer (step S113: Yes), the OPC process is performed relative to the L1 layer (step S115). Particularly, in this embodiment, as described above, therefore, since it is possible to omit the pre-recording operation relative to the L0 layer when the information record apparatus performs the OPC process relative to the L1 layer, it is possible to detect the optimum recording power relative to the L1 layer, more quickly and more appropriately.

On the other hand, if an absolute amount of at least one of width and depth of the groove is not increased in the transmission area of the L0 layer (step S113: No), the recording operation is performed in the transmission area of the L0 layer (step S114), and thereby the recorded state is generated, and the process goes to the aforementioned step S115.

Then, at the optimum laser power calculated at step S115, the data recording is performed relative to the L1 layer (step S116).

Then, it is judged whether or not to terminate the data recording operation (step S117). If the data recording operation is to be terminated (step S117: Yes), a series of recording operation by the information record apparatus is terminated.

On the other hand, if the data recording operation is not to be terminated (step S117: No), it is judged whether or not the aforementioned record layer to be a record object is the L0 layer and the L1 layer (step S102).

On the other hand, as a result of the judgement at step S101, if the data recording operation is not to be started relative to the optical disc 100 (step S101: No), an instruction such as a recording operation start command or the like is waited.

In this embodiment, there is explained a WORM (write once read many) or rewritable optical disc, as a specific embodiment of the information record medium, and there is explained the information record reproduction apparatus of such an optical disc, as a specific embodiment of the information record apparatus. Nevertheless, the present invention can be applied to a multiple-layer type optical disc such as three-layer type, four-layer type and so on, and can be applied to the information record reproduction apparatus of such an optical disc. Furthermore, the present invention can be applied to a large capacity record medium such as a Blu-ray Disc and the like and the information record reproduction apparatus of such a record medium.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-172545 filed on Jun. 10, 2004 including the specification, claims, drawings and summary is incorporated herein by reference in its entirety.

1. An information record medium comprising:
a first record layer for recording first information which is at least a part of record information; and
one or more second record layers disposed on said first record layer, each layer of said second layers being for recording second information which is at least another part of the record information; wherein
said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers,
in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (i) light transmittance under an assumption that the first absolute amount is not increased and said another layer of said second layers and said first record layer are in a recorded state, in comparison to (ii) light transmittance under an assumption that the first absolute amount is not increased and said another layer of said second layers and said first record layer are in a non-recorded state.

2. The information record medium according to claim 1, wherein
in said opposite areas, the first absolute amount is increased and thereby the light transmittance in said opposite areas equals to (i) light transmittance under an assumption that the first absolute amount is not increased and said another layer of said second layers and said first record layer are in the recorded state.

3. The information record medium according to claim 1, wherein
in said predetermined area, a second absolute amount of at least one of width and depth of a groove is increased or decreased and thereby light transmittance in said opposite areas is approached to (i) light transmittance under an assumption that the second absolute amount is not increased or decreased and said another layer of said second layers and said first record layer are in a recorded state, in comparison to (ii) light transmittance under an assumption that the second absolute amount is not increased or decreased and said another layer of said second layers and said first record layer are in a non-recorded state.

4. The information record medium according to claim 3, wherein
in said predetermined area, the second absolute amount is increased or decreased and thereby the light transmittance in said opposite areas equals to (i) light transmittance under an assumption that the second absolute amount is not increased or decreased and said another layer of said second layers and said first record layer are in the recorded state.

5. The information record medium according to claim 3, wherein
said each layer of said second record layers further has a second coloring layer, wherein
in said predetermined area, a thickness of said second coloring layer is increased or decreased and thereby the light transmittance in said opposite areas is approached to (i) light transmittance under an assumption that the thickness of said second coloring layer is not increased or decreased and said another layer of said second layers and said first record layer are in the recorded state, in comparison to (ii) light transmittance under an assumption that the thickness of said second coloring layer is not increased or decreased and said another layer of said second layers and said first record layer are in a non-recorded state.

6. The information record medium according to claim 1, wherein
said first record layer further has a first coloring layer, wherein
in said opposite areas, a thickness of said first coloring layer is increased or decreased and thereby the light transmittance in said opposite areas is approached to (i) light transmittance under an assumption that the thickness of said first coloring layer is not increased or decreased and said another layer of said second layers and said first record layer are in the recorded state, in comparison to (ii) light transmittance under an assumption that the thickness of said first coloring layer is not increased or decreased and said another layer of said second layers and said first record layer are in a non-recorded state.

7. The information record medium according to claim 1, wherein
said predetermined area is a smaller area than each of said opposite areas.

8. The information record medium according to claim 3, wherein
at least one of said first record layer and said second record layers further has a management information record area for recording therein management information, wherein
in said management information record area, there is recorded, as the management information, identification information indicating whether at least one of the first absolute amount and the second absolute amount is increased or decreased.

9. The information record medium according to claim 1, wherein
said another layer of said second layers and said first record layer respectively has a first predetermined area where the power calibration is performed on said another layer of said second layers and said first record layer.

10. The information record medium according to claim 1, wherein
said each layer of said second record layers has a second predetermined area where the power calibration is performed on said each layer of said second record layers, in an area which is different from said predetermined area and not opposite to said opposite areas.

11. The information record medium according to claim 1, wherein
at least one of said first record layer and said second record layer has a management area for recording therein the detected optimum record power value.

12. An information record apparatus for recording a record information into the information record medium comprising: (i) a first record layer for recording first information which is at least a part of the record information; and (ii) one or more second record layers disposed on said first record layer, each layer of said second layers being for recording second information which is at least another part of the record information; wherein (iii) said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers, (iv) in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (iv-1) light transmittance under an assumption that the first absolute amount is not increased and said another layer of said second layers and said first record layer are in a recorded state, in comparison to (iv-2) light transmittance under an assumption that the first absolute amount is not increased and said another layer of said second layers and said first record layer are in a non-recorded state,
said apparatus comprising:
a writing device for writing test writing information which is at least another part of the record information, into said first record layer, by irradiating said first record layer with the recording laser beam in such a manner that the recording laser beam is focused onto said first record layer, and for writing the test writing information into said each layer of said second record layers by irradiating said each layer of said second layers with the recording laser beam in such a manner that the recording laser beam is focused onto said each layer of said second record layers; and
a test writing control device for controlling said writing device so as to (I) test-write the test writing information, via said opposite areas, for a power calibration of the recording laser beam in the predetermined area on said each layer of said second record layers, and (II) test-write the test writing information for the power calibration of the recording laser beam in first predetermined areas included respectively in areas differing from said opposite areas on said another layer of said second layers and said first record layer.

13. An information record method implemented with an information record apparatus provided with a writing device for test-writing test writing information, which is at least another part of the record information, in order to record a record information into a information record medium comprising: (i) a first record layer for recording first information which is at least a part of the record information; and (ii) one or more second record layers disposed on said first record layer, each layer of said second layers being for recording second information which is at least another part of the record information; wherein (iii) said each layer of said second layers has a predetermined area where a power calibration is performed to detect an optimum recording power of recording laser beam transmitted through said first record layer and another layer of said second layers, said another layer of said second layers positioned closer to said first record layer than said each layer of said second layers, (iv) in opposite areas of said another layer of said second layers and said first record layer, said opposite areas being opposite to said predetermined area of said each layer of said second layers, a first absolute amount of at least one of width and depth of a groove is increased and thereby light transmittance in said opposite areas is approached to (iv-1) light transmittance under an assumption that the first absolute amount is not increased and said another layer of said second layers and said first record layer are in a recorded state, in comparison to (iv-2) light transmittance under an assumption that the first absolute amount is not increased and said another layer of said second layers and said first record layer are in a non-recorded state,
said method comprising:
a test writing control process for controlling said writing device so as to (I) test-write the test writing information, via said opposite areas, for a power calibration of the recording laser beam in the predetermined area on said each layer of said second record layers, and (II) test-write the test writing information for the power calibration of the recording laser beam in first predetermined areas included respectively in areas differing from said opposite areas on said another layer of said second layers and said first record layer.
